(19) United States
(12) Patent Application Publication
(10) Pub. No.: US 2010/0196556 A1
(43) Pub. Date: Aug. 5, 2010

(54) CONTAINER SYSTEM

(76) Inventor: James Wheeler, Ashburn, VA (US)

Correspondence Address: SCHMEISER OLSEN & WATTS, 18 E UNIVERSITY DRIVE, SUITE # 101, MESA, AZ, 85201, US

(21) Appl. No.: 12/534,691

(22) Filed: Aug. 3, 2009

Related U.S. Application Data
(60) Provisional application No. 61/150,126, filed on Feb. 5, 2009.

(51) Int. Cl. B65D 81/32; B67D 5/06; B67D 5/00

(52) U.S. Cl. 426/115; 222/1; 222/386

(57) ABSTRACT

A container for containing and dispensing viscous comestibles is disclosed. Viscous comestibles typically include frozen and/or partially frozen comestibles such as ice-cream and frozen and/or partially frozen yogurt, custard, gelato, sorbet, and smoothies. The container comprises a nozzle with a nozzle opening at the proximal end of the container. The distal end of the container body has a distal opening. The container includes a plunger cap, which sealably, frictionably fits within the container body, wherein the plunger cap moves towards the nozzle opening in response to suction applied to the nozzle opening. In some embodiments the container includes a lip at the distal end of the container to retain the plunger cap within the container body. The container can include a dispensing ledge or the container can include a lid, wherein the lid can be repeatably coupled to the nozzle opening.

### CROSS REFERENCE TO RELATED APPLICATION

This application claims priority to U.S. Provisional Patent Application to James Wheeler entitled “Shake-Up Container Systems,” Ser. No. 61/150,126, filed Feb. 5, 2009, now pending, the disclosure of which is hereby incorporated entirely herein by reference.

### BACKGROUND OF THE INVENTION

1. Technical Field

The present invention relates generally to the field of containers and more specifically relates to containers for use with viscous comestibles.

2. State of the Art

Containers and cartridges may be useful for containing various materials such as beverages and foods. Beverages and foods may be heated or cooled to preserve the desired taste, texture and over-all quality of the comestible according to a consumer's preference. Heating comestibles may tend to decrease the viscosity of the product, thereby making it more flowable. Cooling comestibles may tend to increase the viscosity of the product, thereby making it less flowable, potentially creating problems for consuming such products.

Ice cream, a typically cooled comestible, may be purchased in large cartons, pails and scrounds from grocery markets, and in smaller quantities from retail ice cream shops, fast-food restaurants, convenience stores, and concessions. For ice cream, frozen yogurts, and other such products, ideally the temperature of the product should remain low to preserve the desired quality for a reasonable duration; however this greatly increases the viscosity of such products potentially rendering them virtually unflowable from typical containers or cartridges.

Certain containers attempt to solve this problem by designing the container with a lid that is removed to allow the contents to be consumed, thus allowing a disposable utensil to be used by a consumer to spoon out the frozen product. The use of a spoon increases the over-all cost of serving such a product and increases waste since the majority of disposable utensils are discarded after a single use, thereby increasing demand on landfills. In addition, the use of a removable lid also allows the lid to be lost or contaminated. Use of a spoon may also not be practical should the product become less viscous. Further, this style of container is unlikely to prevent any spillage should the container be upset or oriented horizontally.

Other containers may use an oversized straw allowing an individual to consume a semi-frozen beverage by suction means. One problem with this approach is that the frozen, item has varying viscosities because of variations in temperature. A user thus finds themselves looking for warmer, less viscous areas to suck from and often has to simply wait for the product to thaw more fully. Similarly, for frozen products, those with fruit or other objects or very thick viscous products, this alternative may not be feasible. Fruit and other particulates, such as toppings and the like may plug the straw and/or the thick product may not be able to be ‘sucked’ through even an oversized straw. Cones may also be used for serving frozen products such as ice cream; however the cone and ice cream must be consumed within a limited time frame to prevent the ice cream from melting and creating a mess. Cones may also be easily contaminated and become unsanitary should they come into contact with unclean surfaces or hands

Ideally, a container system for storing and dispensing frozen and partially frozen comestibles should comprise a sanitary means to substantially contain liquids and solids at various consistencies and yet remain cost-efficient to manufacture and use. Thus, a need exists for a reliable containment system to consistently purvey frozen foods and beverages in varied environmental conditions and to avoid the above-mentioned problems.

### DISCLOSURE OF THE INVENTION

The present invention relates to a containment and dispensing system for use with high viscosity comestibles. The container may be used to purvey frozen and/or partially frozen comestibles such as ice-cream and frozen and/or partially frozen yogurt, custard, gelato, sorbet and other frozen or partially frozen viscous comestibles. In some embodiments other comestibles are contained such as soup, pudding, applesauce, breakfast yogurt, cheese sauce, or similar products. The container according to the invention comprises a nozzle with a nozzle opening at a proximal end of the container, and a container body with a distal opening at a distal end of the container. The container includes a plunger cap or seal, which sealably, frictionably fits within the container body, wherein the plunger cap moves towards the nozzle opening in response to suction applied to the nozzle opening. In some embodiments the container can include a lip at the distal end of the container body to retain the plunger cap within the container body. In some embodiments the container includes a dispensing ledge. In some embodiments the dispensing ledge is between the container body and the nozzle. In some embodiments the container includes a lid, wherein the lid can be repeatably coupled to the nozzle opening. In some embodiments the lid is tamper-proof. In some embodiments the lid screws onto the nozzle. In other embodiments the lid snaps onto the nozzle.

In some embodiments the nozzle has a taper angle of between 20 and 45 degrees. The nozzle opening can have an area of between 0.78 square inches and 2.4 square inches. The nozzle opening can be oval shaped or round shaped. In some embodiments the interior surface contour of the plunger cap mimics the interior surface contour of the nozzle.

In some embodiments the container includes a container contents comprising a viscous comestible, wherein the viscous comestible has a viscosity that is between 0 and 250,000 centipoise. In some embodiments the container contents comprise a viscous comestible that is maintained at a temperature between −10 and +25 degrees Fahrenheit

A method of distributing a viscous comestible is disclosed comprising filling a container with a viscous comestible and attaching a lid to the container, wherein the lid seals the container, and distributing the container to a point of sale.

In some embodiments filling a container with a viscous comestible comprises locating a plunger cap at a distal end of the container, inserting a viscous comestible dispenser through a nozzle opening in a nozzle end of the container, extruding a predetermined amount of viscous comestible into the container with the viscous comestible dispenser, and extracting the viscous comestible dispenser from the container.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a side view of a container 110 for viscous comestibles according to the invention.

FIG. 2 is a side view of container 110 of FIG. 1 including a cartridge mouthpiece 245 according to the invention.

FIG. 3 is a side view of a consumer using container 110 to dispense viscous comestibles according to the invention.

FIG. 4 is a perspective view of the components of a dispensing system for viscous comestibles 101 using container 110 according to the invention.

FIG. 5 shows how the dispensing system for viscous comestibles of FIG. 4 including container 110 is used.

FIG. 6 shows how plunger cap interior surface 322 of plunger cap 320 mimics nozzle interior surface 324 of nozzle 150 in order to completely dispense the contents of container 110 according to the invention.

FIG. 7 shows an additional method for dispensing viscous comestibles using container system 110 according to the invention using press 410.

FIG. 8 shows a method 510 of distributing a viscous comestible according to the invention.

FIG. 9 shows a method 520 of dispensing a viscous comestible according to the invention.

### DETAILED DESCRIPTION OF EMBODIMENTS OF THE INVENTION

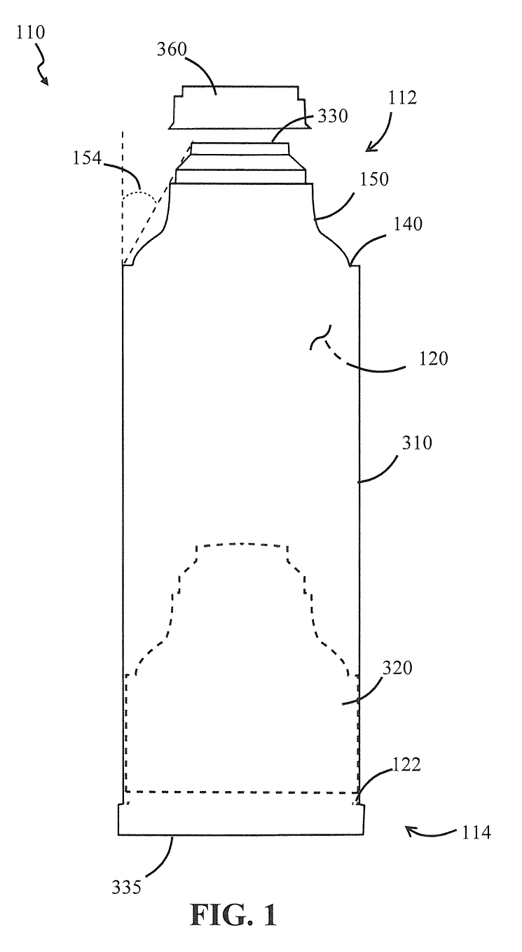

As discussed above, embodiments of the invention relate to a container system for containing and dispensing viscous comestibles. Viscous comestibles typically include frozen and/or partially frozen comestibles such as ice-cream and frozen and/or partially frozen yogurt, custard, gelato, sorbet, and smoothies. Viscous comestible can also include soup, pudding, applesauce, breakfast yogurt, and other similar products. FIG. 1 shows container 110 according to the invention for containing viscous comestibles 120.

Ice-cream is a frozen dessert preferably comprising dairy products such as milk and cream that may be preferably combined with at least one flavoring and/or at least one sweetener and optionally other ingredients. For the purposes of this application the term ice-cream includes traditional ice-cream, frozen custard, frozen yogurt, gelato, sorbet, frozen dairy desserts, smoothies, and other similar products with similar compositions which are also preferably served in a frozen or partially frozen state to provide a smoothly consistent textured product.

Products such as those described above, by nature have consistencies that may be resistant to flow since they are preferably kept in a frigid state. Resistance to flow may be measured by viscosity. Viscosity is a measure of the resistance of a fluid which is being deformed by either shear stress or extensional stress. The viscosity is the resistance of at least one liquid to flow, or its ‘thickness’ and is a means to measure a fluid's friction, which equates to its internal resistance to flow. For example, a liquid such as milk is ‘thinner’, thereby exhibiting a lower viscosity than cream, which is thicker and has a higher viscosity.

The viscosity of ice cream mixtures is affected by the composition of the mixture including the contents of moisture and stabilizers, temperature and length of storage after manufacture. Specifically, the viscosity of ice cream is psuedoplastic in nature meaning, as the sheer rate increases the viscosity decreases. The apparent viscosity also decreases with time of applied sheer stress, a phenomenon known as thixotropy.

The disclosed invention can include viscous comestible contents 120 of container 110 which are a frozen and/or semi-frozen viscous comestible maintained at about −10 degrees F. to about +25 degrees F. Viscous comestible 120 maintained at about −10 degrees to +25 degrees Fahrenheit may be consumed from container 110 without delay in its viscous state, without waiting for the product to soften from the effects of ambient temperature, friction or another artificial heat source. The viscous comestible contents 120 can be ice-cream, for example. Alternatively, the product can be heated by any suitable method to reduce the viscosity and provide a more flowable result. In some embodiments, the disclosed invention includes viscous comestible contents 120 of container 10 that are a viscous comestible with a viscosity in the range of about 0 to 250,000 centiPoise (cP). Viscous comestibles 120 within a range of about 0 to 250,000 cP may be consumed using container 110.

As shown in FIG. 1, container 110 includes proximal end 112 and distal end 141. Distal end 114 includes container body 310 with distal opening 335 at distal end 114 of container 110. Proximal end 112 includes nozzle 150 which in the embodiment shown in FIG. 1 tapers from the larger diameter of container body 310 to the smaller diameter of nozzle opening 330 at proximal end 112 of container 110. Viscous comestible 120 is dispensed through nozzle opening 330. The shape and taper angle of nozzle 150 is optimized to make it easy to dispense frozen comestible 120. Taper angle 154 of nozzle 150 is designed to make it easy to suck comestible 120 into the mouth. Taper angle 154 in FIG. 1 is about 30 degrees, but angles between about 20 and about 45 degrees can be used for taper angle 154.

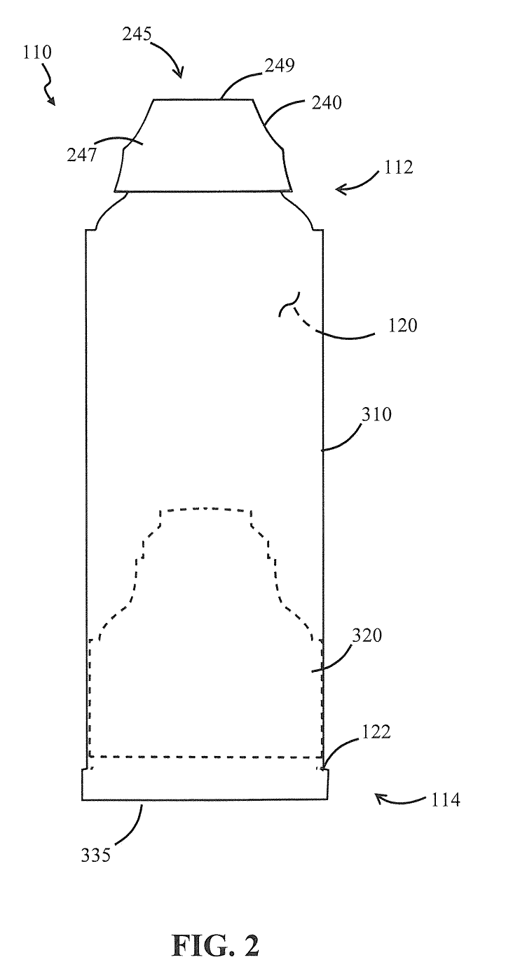

FIG. 2 shows an embodiment of container 110 which includes removable cartridge mouthpiece 245. Cartridge mouthpiece 245 includes cartridge mouthpiece body 247 and cartridge mouthpiece opening 249. Cartridge mouthpiece 245 can be placed over nozzle 150, with comestibles 120 being dispensed through cartridge mouthpiece opening 249. Cartridge mouthpiece nozzle 245 provides additional shape possibilities and options for removing comestibles from container 110. For example, cartridge mouthpiece 245 might be shaped optimally for children or for obtaining a smaller opening 249 than opening 330. Cartridge mouthpiece 245 can be repeatably removed and attached to nozzle 150. Cartridge mouthpiece 245 may be used to create a user-friendly shaped opening to container 110.

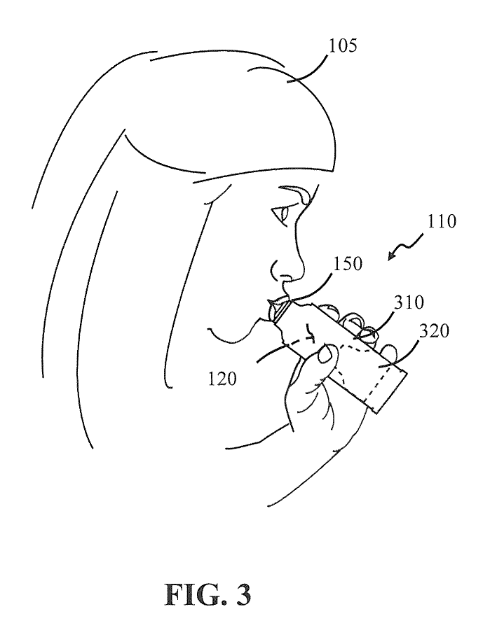

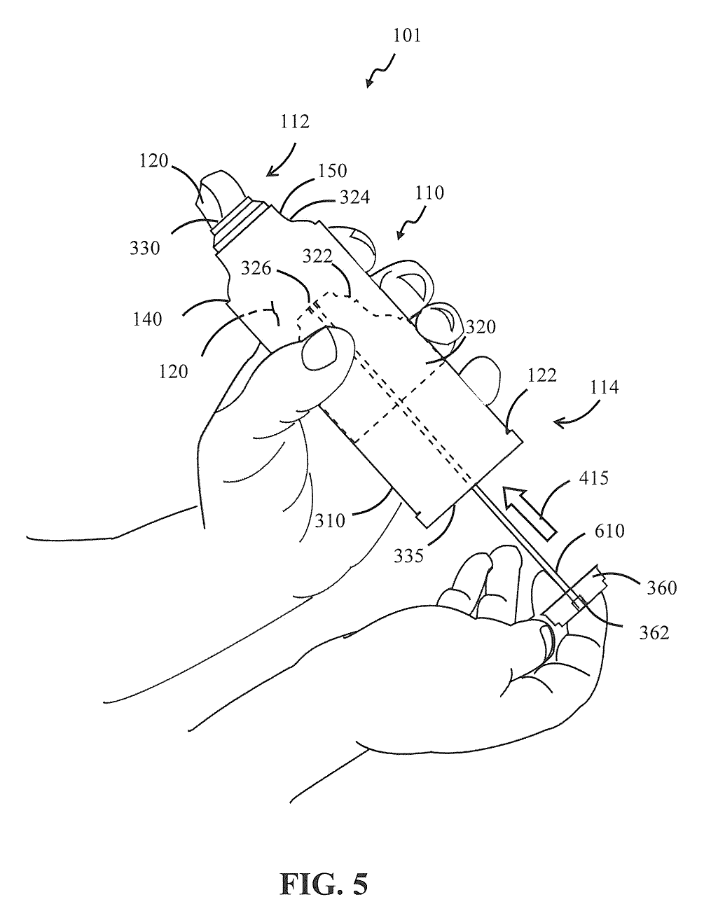

Distal end 114 of container 110 includes opening 335 and lip 122. Opening 335 is used to insert plunger cap 320 into container body 310. Plunger cap 320 retains comestibles 120 within container body 310. Plunger cap 320 seals container body 310 so that comestibles 120 do not exit container body 310 from distal opening 335. Plunger cap 320 fits frictionably within container body 310 so that plunger 320 can be moved from distal end 114 towards proximal end 112. In this way plunger cap 320 is sealably, frictionably fit within container body 310. When plunger cap 320 is moved from distal end 114 towards proximal end 112, viscous comestibles 120 are dispensed from nozzle opening 330 and can be consumed (see FIG. 3 and FIG. 5). Plunger cap 320 can be moved from distal end 114 towards proximal end 112 manually or using push rod 610 as will be explained with FIG. 5. When comestible 120 is dispensed from container 110 through nozzle opening 330 using suction, plunger cap 320 moves towards nozzle opening 330 as comestible 120 is dispensed. This minimizes the amount of air that is allowed into container 110 as comestible 120 is dispensed.

Lip 122 is used to retain plunger cap 320 within container body 310. Plunger cap 320 can be initially inserted through distal opening 335 by mis-shaping it slightly. Once inserted, when container body 310 is filled with comestible 120, comestible 120 will push plunger cap towards distal opening 335 until plunger cap 320 encounters lip 122, at which point plunger cap 320 will stop moving towards distal opening 335 and container body 310 is full. Or alternatively, plunger cap 320 can be placed at distal opening 335 prior to filling container 110 with comestible 120, where again, lip 122 retains plunger cap 320 within container body 310 during the filling process.

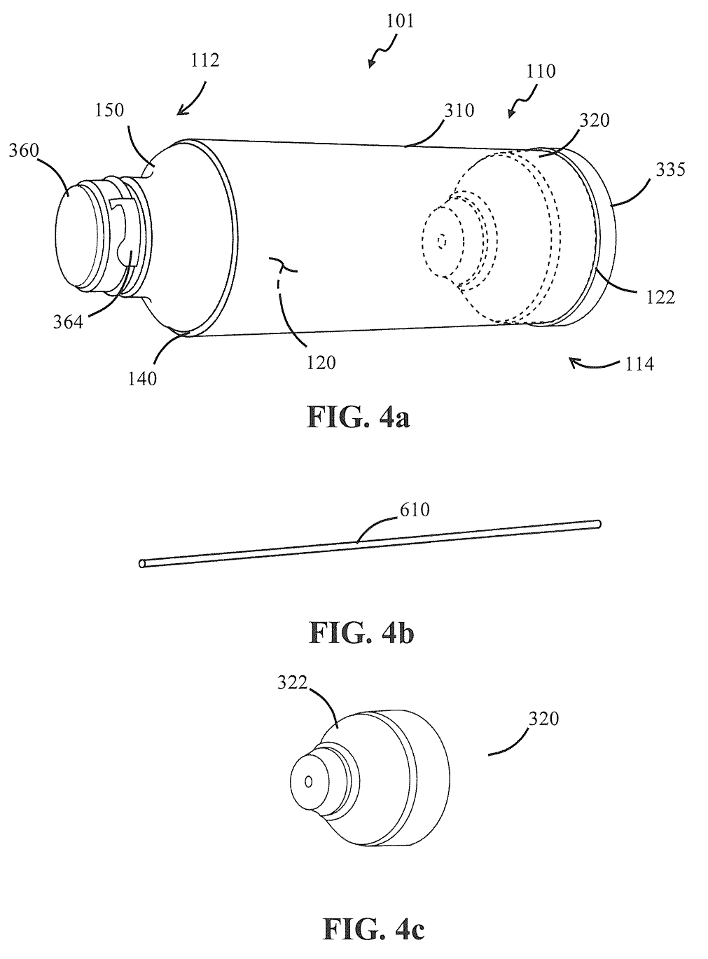

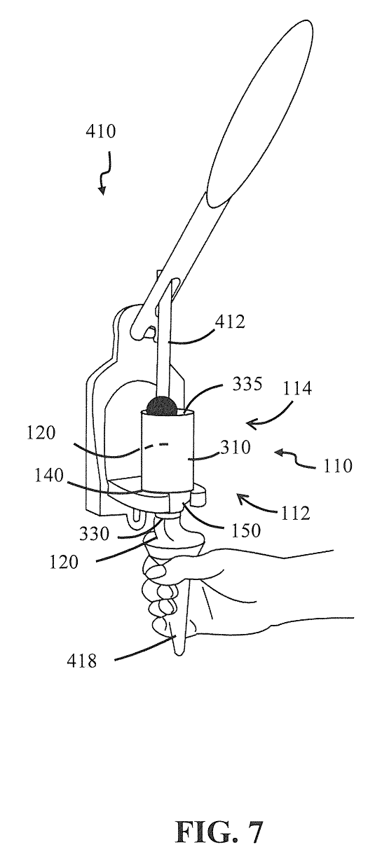

Container 110 also includes dispensing ledge 140 and lid 360 (see FIG. 1). Dispensing ledge 140 is used for an alternate method of dispensing viscous comestible from container 110 as discussed with FIG. 7. Lid 360 may be provided for enclosing proximal opening 330 to substantially prevent spillage. Lid 360 may or may not be sealable to container 110, but preferably will be removably couplable thereto and may serve to provide an isolation means whereby contaminates are substantially prevented from entering proximate opening 330. Lid 360 is repeatably couplable to nozzle 150 in some embodiments. In some embodiments lid 360 is screwed onto nozzle 150. In some embodiments lid 360 may be snapped onto nozzle 150. In some embodiments lid 360 is tamper-proof. Lid 360 being tamper-proof can be implemented in many different ways. A tamper-proof lid generally means one that has means whereby removing the lid or breaking the seal of the lid can be detected. For example, tamper-proof lid 360 can include a tamper detection tab 364 (FIG. 4a) that is broken when lid 360 is removed, similar to lids on milk jugs. Tamper-proof lid 360 can alternatively include a seal that covers nozzle opening 330 so that a consumer can tell when the seal is broken. This seal can be applied to nozzle opening 330 before applying lid 360, or lid 360 can be applied to nozzle opening 330 first and then a seal put around lid 360. A tamper-proof lid 360 is used to enable the consumer to be able to detect if container 10 has been opened after initial sealing of container 110. Any of the methods mentioned and shown herein or other methods can be used to make lid 360 tamper-proof.

Lid 360, when coupled to container 110 may also provide improved stacking and storing means for the invention described herein. Lid 360 may comprise cartridge mouthpiece nozzle 245.

FIG. 3 shows one method of dispensing comestible 120 from container 110 for consumption by consumer 105. Viscous comestible 120 can be sucked from container 110 through proximal opening 330 of nozzle 150 into the consumer's mouth. Proximal opening 330 in nozzle 150 preferably comprises a substantially larger circumference than a conventional straw, thereby allowing the higher viscosity frigid products to be efficiently extracted by suction out of container 110. The larger opening also allows easy extraction of lumped contents such as nuts, fruit, chunks, candy, granola, and similar contents included in viscous comestible 120. Nozzle 150 may be round or may additionally comprise at least one novel shape such as an oval or other suitable shape designed to substantially match the contours of nozzle 150 to more closely fit the contours of the consumer's mouth for a better sealing action, especially that of young children. The increased sealing effect substantially increases the suction force, thereby permitting higher viscosity products to be drawn up and consumed from container 110. Nozzle opening 330 typically has a larger diameter than a straw, but can still fit comfortably in the mouth of a consumer. Nozzle opening 330 can have a shape that is round in some embodiments, or nozzle opening 330 can be oval-shaped in some embodiments. In other embodiments nozzle opening 330 can have other shapes. Nozzle opening 330 has an opening that is between ½ inch diameter which is 0.78 inch surface area and 1.75 inch diameter which is 2.4 inch surface. This range is large enough to allow the more viscous product to be sucked from the container with minimal effort while being small enough to prevent spillage. This is because even at its largest diameter nozzle opening 330 may have a smaller diameter than container body 310, as in the embodiments illustrated. This helps should container 110 tip on it's side at a time when viscous comestibles 120 are less viscous. In this case viscous comestibles 120 will not spill due to the narrowing portion of nozzle 150.

As viscous comestible 120 is sucked from container 110, plunger cap 320 will move towards nozzle 150 due to the frictional seal plunger cap 320 makes against container body 310. This makes it easier to suck comestible 120 from container 110 because air does not need to enter container 110 to replace the volume of viscous comestible 120 extracted. This also keeps viscous comestible 120 fresher and less contaminated because the amount of air that enters container 110 will be minimized and therefore contact between air and viscous comestible 120 will be minimized.

Plunger cap 320 can be used to assist in dispensing viscous comestible 120 from container 110 according to the invention, as shown in FIG. 3. Plunger cap 320 can be pushed towards nozzle 150 using the fingers or other device that can push against plunger cap 320. Placing a force on plunger cap 320 that pushes plunger cap 320 towards nozzle 150 will push viscous comestible 120 out of container 110 through nozzle opening 330 to be consumed.

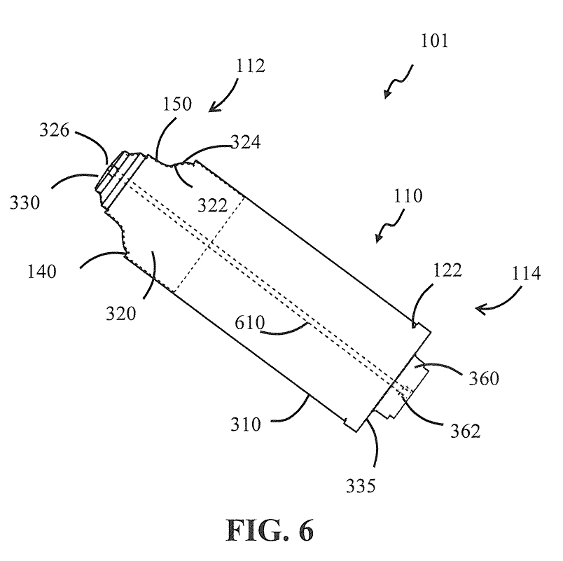

Container 110 can be used as part of dispensing system for viscous comestibles 101 as shown in FIG. 4. FIG. 4 shows a perspective view of the various components of dispensing system 101. FIG. 5 and FIG. 6 show one method of using dispensing system 101. FIG. 4a shows container 110 and its components. FIG. 4b shows push rod 610, use of which is shown in FIG. 5 and FIG. 6. FIG. 4c shows a perspective view of plunger cap 320 outside of container body 310.

In one method of using dispensing system for viscous comestible 101 as shown in FIG. 5 and FIG. 6, lid 360 is first removed from nozzle 150. Push rod 610 is attached to plunger cap 320 via plunger push rod coupling device 326. Plunger push rod coupling device 326 can take many different forms. In FIG. 5 plunger push rod coupling device is shown as a small circular wall which holds push rod 610 from sliding around on plunger 320. The other end of push rod 610 is coupled to the inside of lid 360, which has been removed from nozzle 150. In some embodiments lid 360 includes lid push rod coupling device 362 which can be similar to plunger push rod coupling device 326. Plunger cap 320 can then be moved towards proximal end 112 from distal end 114 of container body 310 in direction 415 by pushing on lid 360 with the fingers as shown in FIG. 5. In this way viscous comestible 120 is dispensed from container 110 in response to moving plunger cap 320 towards nozzle 150 and nozzle opening 330. This movement of plunger cap 320 in direction 415 dispenses viscous comestible 120 from nozzle opening 330 for consumption. In this method plunger cap 320 within container body 310 acts as a piston and a cylinder for extracting comestibles 120 out proximate opening 330 of container 110. Alternatively, according to the invention, push rod 610 can be replaced with fingers or any other device that acts to push plunger cap 320 towards nozzle 150.

A feature of container 110 in some embodiments is that interior surface contour 322 of plunger cap 320 mimics the interior surface contour 324 of nozzle 150. Mimicking the surface contour means that the two surfaces have shapes that nest closely together. For instance, if nozzle 150 is shaped in general like a truncated cone and plunger cap 320 as the same cone—mimicking nozzle 150 shape—with a rounder tip, when the two surfaces are moved together viscous comestible 120 is all pushed out nozzle opening 330 with little left behind. This allows all of viscous comestible 120 within container 110 to be dispensed, as shown in FIG. 6. When plunger cap 320 is moved fully towards nozzle 150, nozzle interior surface 324 and plunger cap interior surface 322 mate closely, with little to no space left between them for comestible 120. As much as possible of viscous comestible 120 is dispensed through nozzle opening 330, with little wasted comestible 120 left behind in container 110.

Further, container 110 comprises at least one dispensing ledge 140. In one embodiment of the invention, a press 410 may be used, separately or in combination with suction by the consumer, to dispense comestibles 120, as shown in FIG. 7. Dispensing ledge 140 is used to stabilize container 110 when used with press 410 or similar assemblies. Preferably, dispensing ledge 140 serves to assist container 10 functionality in the following ways: should a consumer desire a traditional soft serve, container 110 may be placed with proximal end 112 facing down on press 410, with container 110 resting on dispensing ledge 140. Comestible 120 is dispensed into cone 418 by pressing down on plunger cap 320 with plunger 412. However, according to retailer or consumer/customer preference, comestibles 120 may be offered as a novelty by simply having the customer ‘suck’ the comestibles 120 out, thereby eliminating the need to use the press. Dispensing ledge 140 preferably allows container 110 to have dual uses, firstly allowing it to be dispensed as a soft serve, or secondly in combination with nozzle 150 or cartridge mouthpiece 245, comestible 120 can be dispensed by suction means employed by the consumer. In some embodiments container 110 has multiple dispensing ledges. In some embodiments these ledges are different diameters to allow container 110 to be used with different types of presses. In the embodiments of the invention shown in FIG. 1 and FIG. 7, dispensing ledge 140 is located between container body 310 and nozzle 150.

Container 110 may be a single use system or a multiple use system. After use, plunger cap 320 can be removed from container body 310 from distal opening 335 and both components cleaned for refuse or container 110 may be disposed of if used as a single-use system.

Container 110 can comprise substantially unbreakable rigid plastic. Or, in some embodiments, container 110 comprises paper material or other such suitable material or combination of materials. Rigid plastic is preferred since it is durable, cost-efficient to manufacture and because it will most likely be dropped many times during the effective lifetime of the product. In this maimer, container 110 is effectively safe for use by children and adults n many conditions. Thus container 110 comprises a sanitary means to contain and dispense liquids and solids of various consistencies. Container 110 is cost-efficient to manufacture and use.

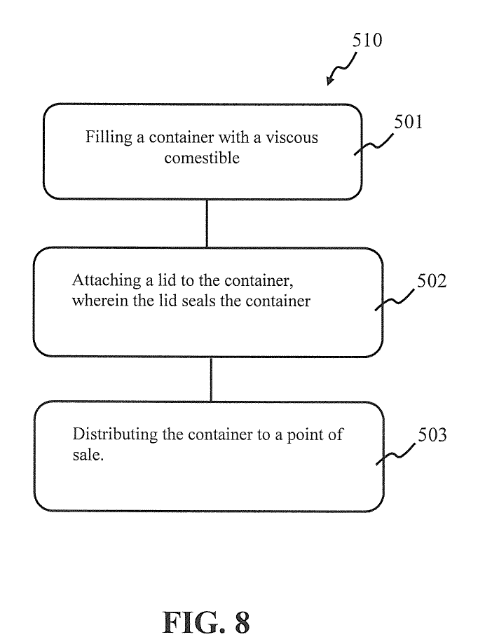

FIG. 8 shows a method 510 of distributing a viscous comestible comprising step 501 filling a container with a viscous comestible, step 502 attaching a lid to the container, wherein the lid seals the container, and step 503 distributing the container to a point of sale. Method 510 can include many other steps. In some embodiments step 501 filling a dispenser with viscous comestibles comprises locating a plunger cap at a distal end of the container, inserting a viscous comestible dispenser through a nozzle opening in a nozzle end of the container, extruding a predetermined amount of viscous comestible into the container with the viscous comestible dispenser, and extracting the viscous comestible dispenser from the container. Method 510 can include many other steps. In some embodiments attaching a lid to the container comprises attaching a tamper-proof seal to the container. In some embodiments method 510 includes step 504 purchasing of the container by a consumer, and step 505 extracting the viscous comestible by the consumer.

In some embodiments step 505 extracting the viscous comestible by the consumer comprises moving a plunger cap towards a nozzle opening to dispense the viscous comestible out of the nozzle opening, and sucking the viscous comestible out of the nozzle opening with the consumer's mouth.

In some embodiments method 510 includes discarding container 110 once it is empty. In other embodiments method 510 can include cleaning container 110 for re-use.

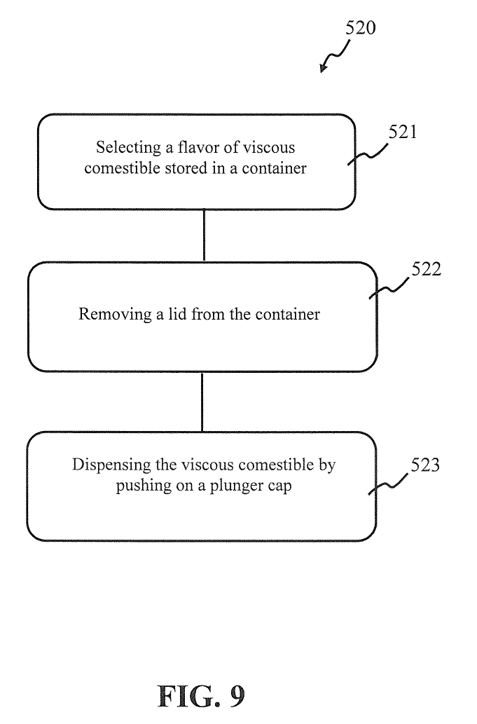

FIG. 9 shows an additional method 520 of dispensing a viscous comestible 120 comprising step 521 selecting a flavor of viscous comestible stored in a container, step 522 removing a lid from the container, and step 523 dispensing the viscous comestible by pushing on the lid. Method 520 can include many other steps, such as step 524 recycling the container.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, the shape of container 110 can be modified to match the contours of the hand, the shape of the nozzle or mouthpiece cartridge or lid can be changed to match consumer preference and need. Elements internal to container 110 can be added to help mix viscous comestible contained. Container 110 can include different compartments, where the consumer breaks the dividing element between the compartments to mix the contents.

1. A container for viscous comestibles comprising:
a nozzle with a nozzle opening at a proximal end of the container;
a container body with a distal opening at a distal end of the container; and
a plunger cap, wherein the plunger cap sealably, frictionably fits within the container body;
wherein the plunger cap moves towards the nozzle opening in response to suction applied to the nozzle opening.

2. The container of claim 1, further including a lip at the distal end, wherein the lip retains the plunger cap within the container body.

3. The container of claim 1, further including a dispensing ledge.

4. The container of claim 1, further including a lid, wherein the lid can be repeatably coupled to the nozzle.

5. The container of claim 1, further including a container contents comprising a viscous comestible, wherein the viscous comestible has a viscosity that is between 0 centipoise and 250,000 centipoise.

6. The container of claim 1, further including a container contents comprising a viscous comestible, wherein the viscous comestible is maintained at a temperature between −10 degrees Fahrenheit to +25 degrees Fahrenheit.

7. The container of claim 1, wherein the nozzle has a taper angle that is between 20 degrees and 45 degrees.

8. The container of claim 1, wherein the nozzle opening has an area that is between 0.78 square inches and 2.4 square inches.

9. The container of claim 1, wherein the nozzle opening has a shape that is either round or oval.

10. The container of claim 1, wherein an interior surface contour of the plunger cap mimics an interior surface contour of the nozzle.

11. The container of claim 1, wherein the plunger cap has a push rod coupling device.

12. The container of claim 3, wherein the dispensing ledge is located between the container body and the nozzle.

13. The container of claim 4, wherein the lid screws onto the nozzle.

14. The container of claim 4, wherein the lid snaps onto the nozzle.

15. The container of claim 4 wherein the lid is tamper-proof.

16. A method of distributing a viscous comestible comprising:
filling a container with a viscous comestible;
attaching a lid to the container wherein the lid seals the container; and
distributing the container to a point of sale.

17. The method of claim 16, wherein filling a container with a viscous comestible comprises:
locating a plunger cap at a distal end of the container;
inserting a viscous comestible dispenser through a nozzle opening in a nozzle end of the container;
extruding a predetermined amount of viscous comestible into the container with the viscous comestible dispenser; and
extracting the viscous comestible dispenser from the container.

18. The method of claim 16 wherein attaching a lid to the container comprises attaching a tamper-proof seal to the container.

19. The method of claim 16, further comprising:
purchasing of the container by a consumer;
extracting the viscous comestible by the consumer.

20. The method of claim 19, wherein extracting the viscous comestible by the consumer comprises:
moving a plunger cap towards a nozzle opening to dispense the viscous comestible out of the nozzle opening; and
sucking the viscous comestible out of the nozzle opening with the consumer's mouth.
